(19) United States
(12) Patent Application Publication
(10) Pub. No.: US 2016/0078474 A1
(43) Pub. Date: Mar. 17, 2016

(54) APPARATUS AND METHODS FOR MEASUREMENT OF CAMPAIGN EFFECTIVENESS

(71) Applicant: DataLogix, Inc., Westminster, CO (US)

(72) Inventors: Damian Vallejo Wandler, Denver, CO (US); Craig J. Johns, Northglenn, CO (US); Robin Opie, Lafayette, CO (US)

(73) Assignee: DataLlogix, Inc., Westminster, CO (US)

(21) Appl. No.: 14/486,186

(22) Filed: Sep. 15, 2014

(51) Int. Cl. G06Q 30/02

(52) U.S. Cl. CPC G06Q 30/0246

(57) ABSTRACT

In some embodiments, a method defines a control group of consumers from a population of consumers that meet a first criterion associated with a promoted entity. The method further includes calculating an aggregate first per-consumer-purchase amount for the promoted entity based on one or more consumer characteristics of the control group. The method further includes defining a test group of consumers from a population of consumers that meet a second criterion associated with the promoted entity, and calculating an aggregate second per-consumer-purchase amount for the promoted entity based on the one or more consumer characteristics of the test group. The method further includes sending a signal indicative of a net purchase value based on a difference between the aggregate first per-consumer purchase amount and the aggregate second per-consumer-purchase amount.

### BACKGROUND

Some embodiments described herein relate generally to methods and apparatus for measurement of effectiveness of an advertising campaign.

In digital media, online advertisements can be tied to online purchases of specific products and/or through specific retailers. Consequently, when consumers complete the majority of their transactions online, an entity can establish that internet advertising is effective for direct response and for targeting ‘almost ready to buy’ consumers. However, consumer behavior can be a result of multiple factors, some of which are unrelated to the targeted advertising. Such unrelated factors can have a confounding effect on determining effectiveness of the targeted advertising.

A need exists, therefore, for methods and apparatus for measurement of effectiveness of an advertising campaign.

### SUMMARY

In some embodiments, a method defines a control group of consumers from a population of consumers that meet a first criterion associated with a promoted entity. The method further includes calculating an aggregate first per-consumer-purchase amount for the promoted entity based on one or more consumer characteristics of the control group. The method further includes defining a test group of consumers from a population of consumers that meet a second criterion associated with the promoted entity, and calculating an aggregate second per-consumer-purchase amount for the promoted entity based on the one or more consumer characteristics of the test group. The method further includes sending a signal indicative of a net purchase value based on a difference between the aggregate first per-consumer purchase amount and the aggregate second per-consumer-purchase amount.

### BRIEF DESCRIPTION OF THE DRAWINGS

FIGS. 1A-1C illustrate exemplary plots for measurement of campaign effectiveness. FIG. 1A illustrates post-campaign spend for a population of consumers; FIG. 1B illustrates spend error for the population of consumers of FIG. 1A; and FIG. 1C illustrates average spend errors for test (dark circles) and control (light grey circles) groups of the population of consumers of FIG. 1A.

FIG. 2 is a block diagram of an apparatus, according to an embodiment.

FIGS. 3A-3E illustrate exemplary plots, according to embodiments. FIG. 3A illustrates exemplary scatterplot data; FIG. 3B illustrate the scatterplot data of FIG. 3A having a logarithmic function fitted thereto; FIG. 3C illustrate the scatterplot data of FIG. 3A having a smoothing function fitted thereto; FIG. 3D illustrates the scatterplot data of FIG. 3A transformed by the smoothing function of FIG. 3C; FIG. 3E illustrates groups (horizontal lines) of the scatterplot data of FIG. 3A having a smoothing function fitted thereto; and FIG. 3F illustrates the groups of scatterplot data of FIG. 3E transformed by the smoothing function of FIG. 3E.

FIG. 4 is a flow chart illustrating a method according to an embodiment.

FIG. 5 illustrates an exemplary interface, according to an embodiment.

### DETAILED DESCRIPTION

In some embodiments, a method includes defining a control group of consumers from a population of consumers that meet a first criterion associated with a promoted entity. The method further includes calculating an aggregate first per-consumer-purchase amount for the promoted entity based on one or more consumer characteristics of the control group. The method further includes defining a test group of consumers from a population of consumers that meet a second criterion associated with the promoted entity, and calculating an aggregate second per-consumer-purchase amount for the promoted entity based on the one or more consumer characteristics of the test group. The method further includes sending a signal indicative of a net purchase value based on a difference between the aggregate first per-consumer purchase amount and the aggregate second per-consumer-purchase amount.

In some embodiments, the first criterion includes that the control group has not been exposed to one or more communications about the promoted entity. In some embodiments, the second criterion includes that the test group has been exposed to one or more communications about the promoted entity. In some embodiments, at least one communication associated with the promoted entity is an online advertisement for the promoted entity.

In some embodiments, an apparatus includes a consumer module configured to define a control group of consumers from a population of consumers that meet a first criterion associated with a promoted entity. The apparatus further includes a measurement module configured to calculate an aggregate first-per-consumer-purchase amount for the promoted entity based on one or more consumer characteristics of the control group. The measurement module is further configured to define a test group of consumers from a population of consumers that meet a second criterion associated with the promoted entity. The measurement module is further configured to calculate an aggregate second-per-consumer purchase amount for the promoted entity based the one or more consumer characteristics of the test group. The measurement module is further configured to send a signal indicative of a net purchase value based on a difference between the aggregate first -per-consumer purchase amount and the aggregate second -per-consumer-purchase amount.

In some embodiments, a non-transitory processor-readable medium stores code representing instructions to cause a processor to perform a process, the code including code to define a control group of consumers from a population of consumers that meet a first criterion. The code further includes code to calculate an aggregate first-per-consumer-purchase amount for the promoted entity based on one or more consumer characteristics of the control group. The code further includes code to define a test group of consumers from a population of consumers that meet a second criterion, and to calculate an aggregate second-per-consumer purchase amount for the promoted entity based on the one or more consumer characteristics of the test group. The code further includes code to send a signal indicative of a net purchase value based on a difference between the aggregate first-per-consumer purchase amount and the aggregate second-per-consumer-purchase amount.

While the communication of the promoted entity is described herein (for simplicity) as one that can potentially result in a transaction/purchase, it is understood that aspects of the invention are not limited to such embodiments, and are generally applicable to any communication that can potentially result in related online and/or offline activity of interest. For example, the communication can be an awareness campaign seeking donations, and the tracked activity can be related donations. In another example, the communication can be a petition, and the tracked activity can be sign-ups for the petitions. In yet another example, the communication can be for an event, and the tracked activity can be registrations for the event.

As used herein, a module can be, for example, any assembly and/or set of operatively-coupled electrical components, and can include, for example, a memory, a processor, electrical traces, optical connectors, software (executing in hardware), and/or the like. As used herein, the singular forms “a,” “an” and “the” include plural referents unless the context clearly dictates otherwise. Thus, for example, the term “a database” is intended to mean a single database or a set of databases. Furthermore, as described herein, an entity, for example a business entity associated with a computing device, can be a marketing entity, a website and/or website operator, an online and/or an offline store, a data analytics entity, etc.

An exemplary embodiment of operation of aspects of the disclosure is provided herein. Consider a population of consumers, some of which are targeted for and/or exposed to one or more communications (e.g., online advertisements) about a promoted entity (e.g., a product, or a service) as part of a campaign, while others are not targeted/are unexposed. Each consumer has characteristic information associated therewith that is unrelated to the campaign, such as demographic information, digital activity level, and/or the like. In some embodiments, the spending of each consumer on the promoted entity prior to the campaign, or “pre-campaign” (generally, transaction information) is known. Then, the spending of each consumer on the promoted entity post-campaign (estimated spend), based on the pre-campaign transaction information, can be estimated via computational, predictive, and/or other mathematical means, as will be discussed in more detail later. Further, after the campaign ends (“post-campaign”), the observed spending (observed spend) of each consumer on the promoted entity is known.

For each consumer then, an error in the estimate can be calculated, which is the difference (spend error) between the observed spend and the estimated spend can be calculated. Hence, the spend error can be calculated in a similar manner for all consumers, irrespective of whether they were exposed to the one or more communications or not.

To determine the effectiveness of the campaign, the purchasing behavior of the exposed consumers must be compared to that of the unexposed consumers. In some embodiments, the population of consumers, with known spend errors, can be filtered based on the criterion of whether they were exposed to the communications or not. In this manner, spend errors can be analyzed for a “test group” of consumers that were exposed to the communications and can be more likely to have changed purchasing behavior for the promoted entity, and for a “control group” of consumers that were not exposed to the communications, such that any changes in purchasing behavior for the promoted entity by the control group are attributable to factors other than the communications.

An average spend error can be calculated for both the test group and the control group. The difference between the average spend error of the test group and the average spend error for the control group (spend difference) can be a measure of the effectiveness of the campaign. As an example, consider a population of consumers where some are exposed to an online advertisement for a product, while others are not. Assume the estimated spend of each consumer varies between $0 and $10, that the observed spend varies between $0 and $20. The spend error can be the difference between the observed spend and the estimated spend. When the population of consumers is filtered based on exposure to the campaign into test (exposed) and control (unexposed) groups, a test group will typically have a higher spend error, say an average spend error of $5. Conversely, a control group can have a lower spend error, say an average spend error of $−3. The negative value for the average spend error for the control group indicates other reasons (i.e., other than the campaign) that the purchasing behavior of the control of consumers could have been lower than estimated. Accordingly, the difference between the average spend error for the test group ($5) and the average spend error for the control group ($−3) is $8. Additionally or alternatively, the estimated spend can be calculated such that the average spend error for the control group is $0 and the average spend error for the test group is $8, the difference remains $8. While the example above described the exposed group having a positive error and the unexposed group having a negative error, both the exposed and unexposed groups could have positive or negative errors.

The selection of consumers for the test group and the control group can be further filtered based on other criterion, such as demographics and digital activity. In this manner, the influence of these characteristics on the purchasing behavior of the test group and the control group is controlled, and the difference between the average spend error for the test group and the average spend error for the control group can be a more accurate representation of the effectiveness of the campaign. Referring to the same example as above, if the test group and the control group are limited to consumers having a household income of >$100,000, then the average spend error for the test group can be $8, and the average spend error for the control group can be $−4, such that the difference is now $12. Said another way, the campaign appears to have been more effective in consumers of the particular income bracket than in general ($12 vs. $8). It is understood that the control group and the test group can be (optionally) filtered on any suitable criterion, in addition to the unexposed vs. exposed distinction.

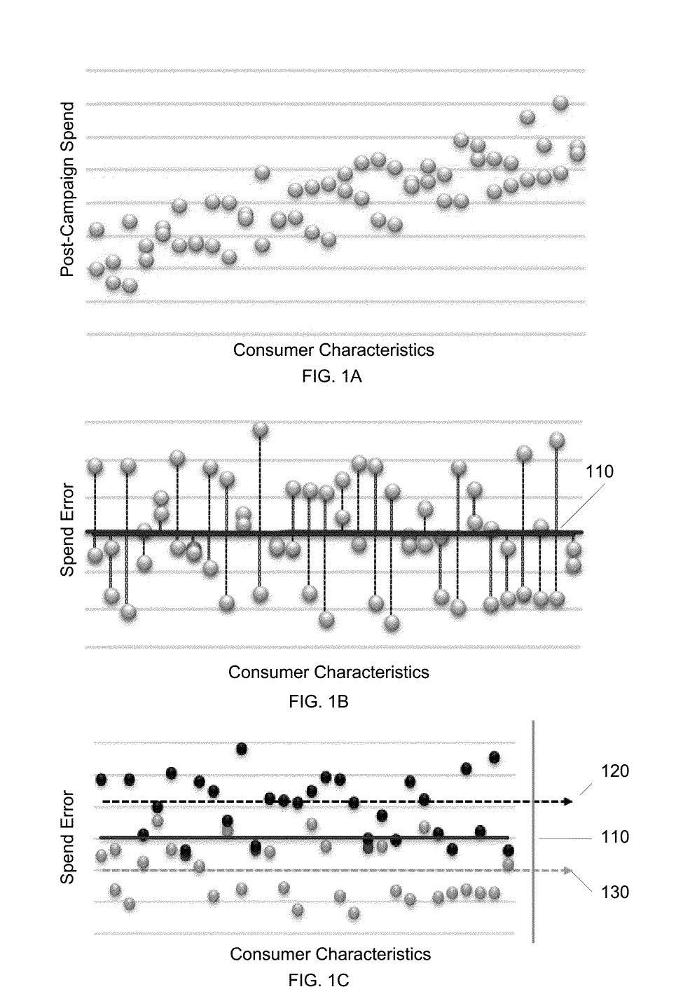

FIG. 1A is an exemplary plot of post-campaign spend for a population of consumers vs. the consumer characteristics, which can be any of the characteristic listed above, and combinations thereof For example, the consumer characteristic can be a digital activity score. FIG. 1B illustrates the spend error for the population of consumers vs. the consumer characteristics, with the horizontal line 110 indicating a spend error of about zero. FIG. 1C illustrates the average spend error (top line 120 for a test/exposed group of the population of consumers of FIG. 1B, bottom line 130 for a control/unexposed group of the population of consumers of FIG. 1C. The difference between the lines 120, 130 is then a measure of campaign effectiveness. In the example above, top line 120 could be +$8 and bottom line 130 could be −$4.

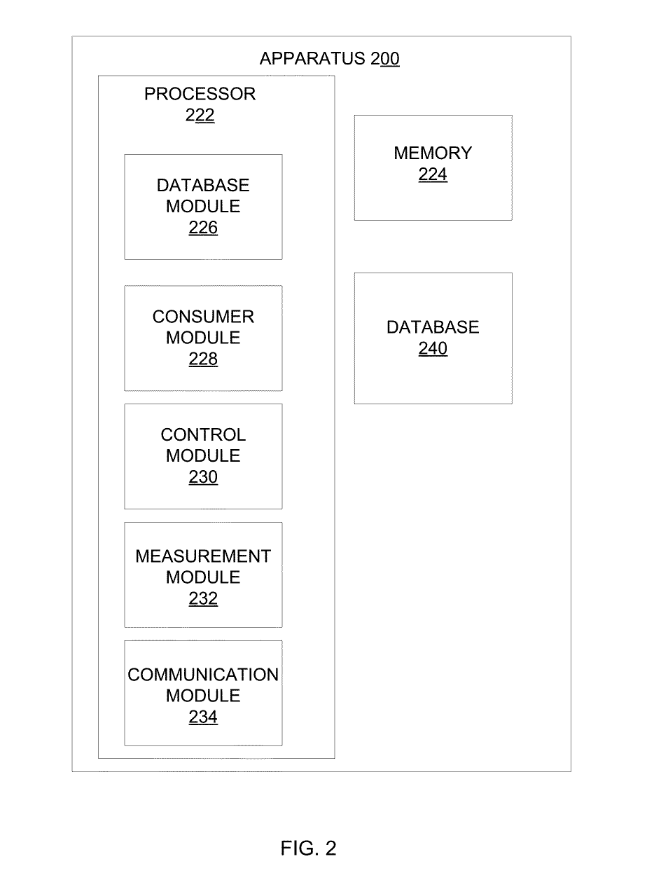

FIG. 2 is a schematic illustration of apparatus 200 within which aspects of the invention can be implemented, according to an embodiment. In some embodiments, the apparatus 200 is configured for measurement of campaign effectiveness, as described in more detail below. The apparatus 200 includes a processor 222 and a memory 224. The processor 222 includes at least a consumer module 228 and a measurement module 232. The processor 222 can also include a communications module 234 for establishing and managing network connectivity of the apparatus 200, such as with, for example, one or more data sources (not shown) and/or a remote user (not shown) of the apparatus. The processor 222 can also include a control module 230 for manipulating aspects of the apparatus 200 and/or any of the other modules described here, such as by a local and/or remote user (not shown). It is to be understood that each of the modules may be in seamless communication with each other module.

The apparatus 200 can further include a database 240 distinct from the memory 224. In other embodiments, the memory 224 and the database 240 can be the same, and in yet another embodiment, the database 240 can be external to the apparatus 200.

The apparatus 200 can be in communication with other entities, such as the data sources and/or a remote user as mentioned above, via a network, which can be any type of network (e.g., a local area network or LAN, a wide area network or WAN, a virtual network, a telecommunications network, and/or the internet), implemented as a wired network and/or a wireless network. Any or all communications can be secured (e.g., encrypted) or unsecured, as is known in the art. The apparatus 200 can encompass a personal computer, a server, a database, a work station, a mobile device, a cloud computing environment, an application or a module running on any of these platforms, and/or the like.

In some embodiments, the database 240 and/or the memory 224 can hold data suitable for measurement of campaign effectiveness (e.g. for a specific advertising campaign). In some embodiments, the data can include advertising data and/or transaction data for the one or more promoted entities, including all relevant associated information (e.g. retailer information, customer demographics, and/or the like). In some embodiments, the promoted entity is a product and/or retailer, and the data includes household data associated with one or more of the following: a mass channel population, an advertising campaign population, a drug channel population, a grocery channel population, a supercenter channel population, and/or the like. In some embodiments, the data includes channel data for the one or more promoted entities, such as might be sourced directly from a manufacturer, distributor and/or any distribution chain entity for a product, for example. In some embodiments, the data includes transaction data, which can be point-of-sale based, and/or which can be at the stock keeping unit (SKU) level. In some embodiments, the database 240 and/or the memory 224 can be populated with consumer data in a manner similar to as described in related application Ser. No. 13/771,627 (“the '627 application”) titled “SYSTEM AND METHOD FOR MEASURING ADVERTISING EFFECTIVENESS”, filed on Feb. 20, 2013, the disclosure of which is incorporated herein by reference in its entirety.

The consumer module 228 is configurable to define a control group of consumers from a population of consumers in any suitable manner. In some embodiments, the control group includes consumers that meet a first criterion associated with a promoted entity. In some embodiments, the promoted entity is one or more of the following: a product, a class of products, a brand of a product, a retailer, a manufacturer, a group, an organization, and a professional service.

In some embodiments, the population of consumers, which can be stored in the database 240 and/or the memory 228, can be defined from a matched consumer record set that includes each record from a first consumer record set that has hashed an attribute string equal to a hashed attribute string of a record from a second consumer record set. As an example, a first consumer record set and the second consumer record set can be associated with campaign data and transaction data respectively, and the hashed attribute string can be a household identifier (HHID) used to match the two to generate the matched consumer record. In some embodiments, the hashed attribute string is generated as disclosed in U.S. patent application Ser. No. 13/644,736 filed Oct. 4, 2012 (“the '736 application”), titled “METHOD AND APPARATUS FOR MATCHING CONSUMERS”, the disclosure of which is incorporated herein in its entirety by reference.

In some embodiments, the first criterion specifies, includes, and/or otherwise requires, at least in part, that the control group has been exposed to no more than a first threshold level of communications about the promoted entity. In some embodiments, the threshold level includes zero and/or none; said another way, in some embodiments, the first criterion specifies, includes, and/or otherwise requires, at least in part, that the control group has not been exposed to any communications about the promoted entity, and can encompass embodiments where a household that was targeted for the campaign but never received an impression associated with the campaign is included in the control group.

In some embodiments, the control group of consumers is selected based on the test group, and in a manner as substantially described in the '627 application. For example, in some embodiments, consumer module 228 is further configurable to define the control group such that the control group of consumers are similar to the test group of consumers based on one or more similarity criterion such as matching and/or alignment characteristics. Said another way, the control group can be ‘aligned’ and/or otherwise matched with the test group based on these ‘alignment’ characteristics. The similarity criterion can include, but not limited to, pre-campaign spending/transaction information for the promoted entity, demographic makeup/information, digital activity information, and/or the like. In some embodiments, households can be selected for the control group based on transaction data that is acquired from a specific retailer, a data partner with whom a contractual relationship exists, and/or the like. In some embodiments, the control group of consumers is selected based on a hybrid of the approaches provided above. In some embodiments, the consumer module 128 is configurable to perform one or more diagnostic assessments on the control groups for statistical soundness, as also disclosed in the '736 application. In some embodiments, the alignment of the control group can be done through weighting. Said another way, to align the control group some underrepresented groups may count more than other groups (e.g., more than once) and some overrepresented groups may count less than other groups (e.g., less than once).

The consumer module 228 is further configurable to define a test group of consumers from the population of consumers in any suitable manner. In some embodiments, the test group includes consumers that meet a second criterion associated with the promoted entity. In some embodiments, the second criterion specifies, includes, and/or otherwise requires, at least in part, that the control group has been exposed to at least a second threshold level of communications about the promoted entity such as, for example, at least 30%, at least three of ten communications associated with the campaign, at least one online and at least one offline communication, and/or the like. In some embodiments, the threshold level is that the consumer was exposed to at least one communication; said another way, in some embodiments, the second criterion specifies, includes, and/or otherwise requires, at least in part, that the control group has been exposed to any communications about the promoted entity. In some embodiments, the test group of consumers is selected in a manner as substantially described in the '627 application. In some embodiments, the test group of consumers is selected based on a hybrid of the approaches provided above.

The measurement module 232 is configurable to calculate an aggregate first per-consumer-purchase amount for the promoted entity for the unexposed group. In some embodiments, the one or more consumer characteristics are selected from pre-communication transaction information for the promoted entity, demographic information, and digital activity information. For example, in some embodiments, the first per-consumer-purchase amount is calculated based on the predicted post-campaign spending at the household level for some or all households in the control group. As another example, the first per-consumer-purchase amount can be calculated based on the predicted post-campaign spending at the household level for a particular demographic within the control group and/or the test group, for households in the control group and/or the test group that have a threshold level of digital activity, and/or the like. In some embodiments, an analysis of covariance (ANCOVA) approach can be used to predict post-campaign spending at the household level for households in the control group.

In some embodiments, the one or more consumer characteristics do not include a consumer purchase amount. Said another way, the consumer characteristics do not provide any measure, directly or indirectly, of observed post-campaign spending/transaction information.

In some embodiments, for example, the observed post-campaign spending for the control group can be represented with the model shown in Eq. 1:

Y=α+β₁f₁(X₁)+β₂f₂(X₂)+. . . βₖfₖ(Xₖ)+ε (1)

Where Y is the observed post-campaign spending/sales, α, β₁, β₂, . . . βₖ are linear model coefficients and c is the unexplained error in the model. As an example, X₁ can denote household income, X₂ can denote pre-campaign spending/sales, and so on for Xₖ variables. In some embodiments, f₁, f₂, . . . fₖ are functions used for transformation of the respective variables X₁, X₂, . . . Xₖ such that fᵢ(Xᵢ) has a substantially linear relationship with Y for any i=1, 2, . . . , k. In some embodiments, each of the f₁, f₂, . . . fₖ functions can be independently and/or empirically estimated, since each of the X₁, X₂, . . . Xₖ variables can have a different relationships with Y. As non-limiting examples, each of the f₁, f₂, . . . fₖ functions can independently take forms such as a logarithmic function, a smoothing function, an exponential function, a square root function, and/or the like. Explained with reference to a single function f₁ without loss of generality, in some embodiments, the form of f₁ is determined based on a sample data set from the control population. In this manner, when the number of households is large, employing a sample of households for determining the form of f₁(X₁) can be computationally efficient and can prevent over-fitting the data. In some embodiments, the smoothing function f₁(X₁) is determined in the following manner: the values for X₁ are split into a predetermined, dynamically determined, or manually determined number of groups (groups g=1, 2, . . ., G), and for each group, an average post-campaign spend, Y̅_{g}, is determined In some embodiments, each group must contain a minimum number of households. Finally, for each group, f₁(X₁) is then equal to Y̅_{g}, the calculated mean for that group. Said another way, every X₁ value can be mapped to one of the G groups, and f₁(X₁) is equivalent to Y̅_{g} for each mapping. As a non-limiting example, g=1 contains all X₁ values 0 to 2 and g=2 contains all X₁ values over 2 to 4. If Y̅₁=1.4 and Y̅₂=1.9 then f₁(X₁) is equal to 1.4 and 1.9 for groups 1 and 2 respectively.

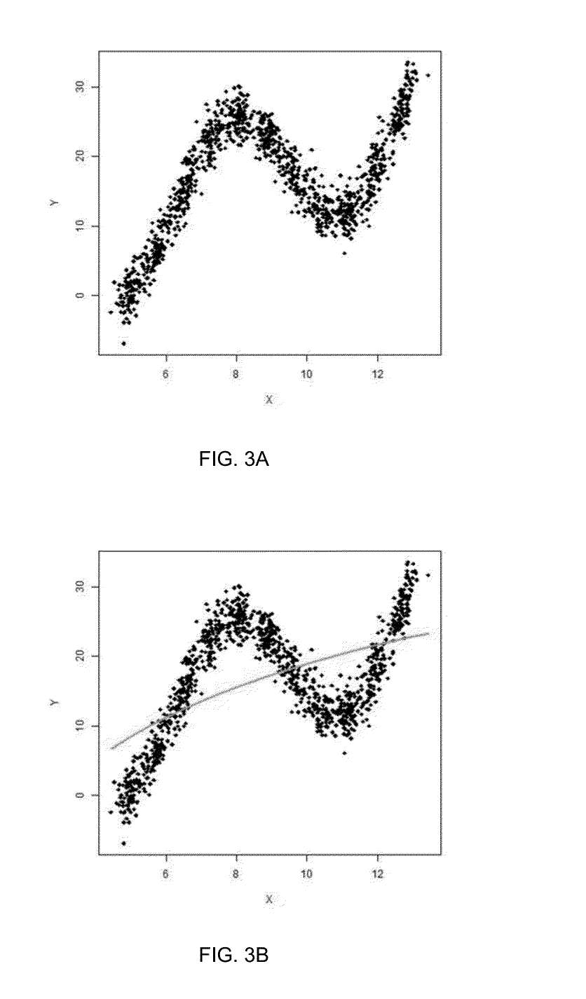

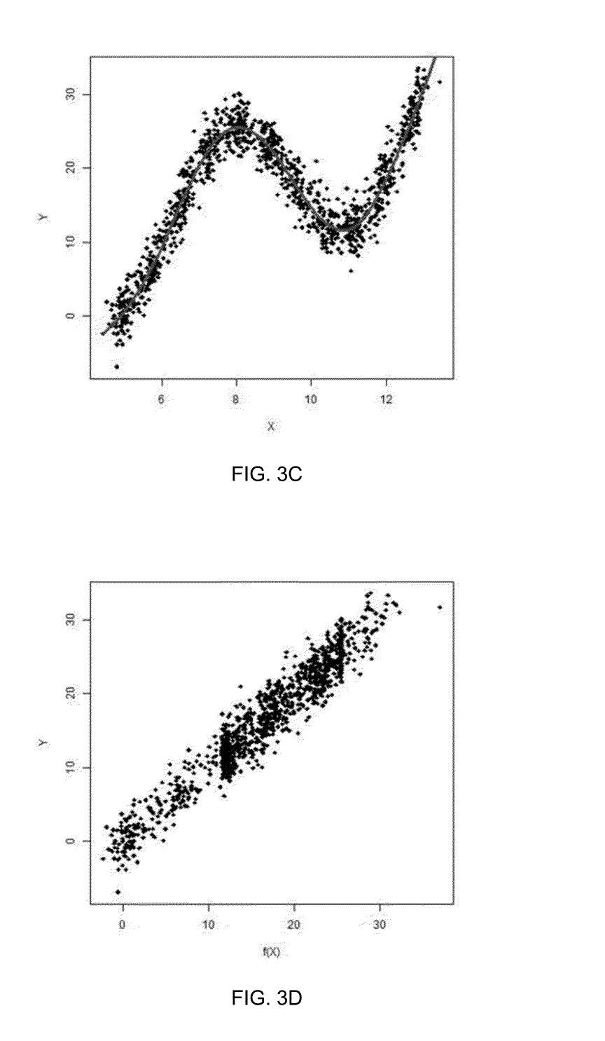

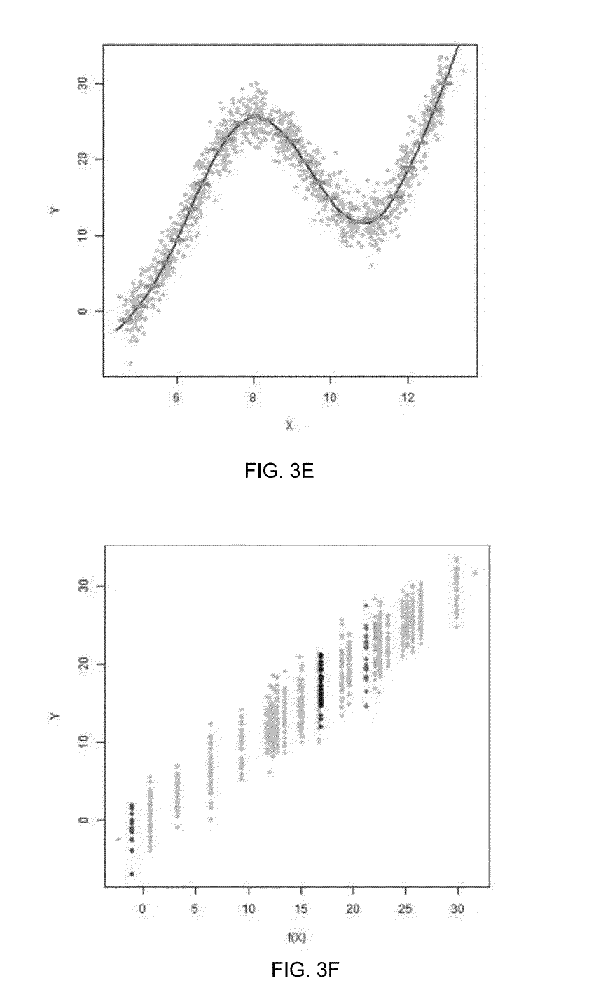

FIGS. 3A-3F illustrate an example of how each of the f functions can be determined, for an exemplary X variable. FIG. 3A illustrates exemplary X, Y scatterplot data, such as, for example, X₁ and the Y described above. The illustrated scatterplot data is non-linear, and as illustrated in FIG. 3B, not amenable to be fitted to a logarithmic function (slight curvature), i.e., defining the f transformation to be a log function is not suitable in this instance. FIG. 3C illustrates that a smoothing function (line in FIG. 3C) fits the data well. FIG. 3D illustrates how a plot of f(X) is linear with Y. Accordingly, f is determined to be a smoothing function. Such an approach, while useful, can be computationally expensive. An alternative approach can be to determine f(X) based on subsets of X values, where the X values are split into groups, which are illustrated by the horizontal lines in FIG. 3E. Each horizontal line is calculated as Y̅_{g} for any group g a step function describing the relationship between Y and X. FIG. 3F accordingly shows a plot of Y versus the f(X) calculated from the step function (horizontal lines). This alternative approach, while still approximating the information in FIG. 3D, can be more computationally efficient.

After the f₁, f₂, . . . fₖ functions are determined, the α, β₁, β₂, . . . βₖ parameters can be calculated in any suitable manner such as, as non-limiting examples, via least squares regression, maximum likelihood, or other appropriate methods.

Once the α, β₁, β₂, . . . βₖ parameters, and the f₁, f₂, . . . fₖ functions have been estimated, in some embodiments, an estimated post-campaign spend can be calculated as Ŷ=\hat{α}+\hat{β}₁f₁(X₁)+\hat{β}₂f₂(X₂)+. . . +\hat{β}ₖfₖ(Xₖ). This estimate can be calculated for all households.

In some embodiments, the measurement module 132 can be further configurable to calculate a first per-consumer-purchase amount. In some embodiments, the first per-consumer-purchase amount is calculated based on the known post-campaign spending at the household level (i.e., Y) for some or all households in the control group. Said another way, the measurement module 232 is configurable to both estimate as well as receive observed consumer spending information for the promoted entity post-campaign. In some embodiments, the-first per-consumer-purchase amount is calculated based on the difference between the known post-campaign spending (Y) and the estimated post-campaign spending (Ŷ, above), as illustrated in Eq. 2:

e_{c}=Y_{c}−Ŷ_{c} (2)

where ε is an estimate of the model error ε in Eq. 1. and the subscript c represents the notion that the observed and predicted post-campaign spend/sales are for control-households.

In some embodiments, the model is fit to the control group so the sum of the e_{c} values for the entire control group will be substantially zero, and can be a non-zero value when the sum is taken over a subgroup within the control group. In some embodiments, the control group can be defined using weights, and the model and/or any summaries on the e_{c} parameter can be computed while applying the weights.

In some embodiments, the aggregate first per-consumer-purchase amount for the control group and/or a subgroup thereof is the average, sum, median, and/or the result of any other suitable mathematical operation(s), linear or non-linear, on the difference between the known post-campaign spending for the control group and the estimated post-campaign spending for the control group and/or a subgroup thereof

The measurement module 232 is further configurable to calculate a second-per-consumer purchase amount for the promoted entity based on the one or more consumer characteristics of the test group. In some embodiments, the second per-consumer-purchase amount is calculated based on the observed post-campaign spending at the household level for some or all households in the test group. For example, the second per-consumer-purchase amount can be calculated based on the observed post-campaign spending at the household level for a particular demographic within the control group and/or the test group, for households in the control group and/or the test group that have a threshold level of digital activity, and/or the like. Said another way, the same selection criterion can be employed for selecting some of the households in the control group and some of the households in the test group, so as to minimize the effect of the selection criterion itself

In some embodiments, the second per-consumer-purchase amount is calculated based on the estimated post-campaign spending at the household level for some or all households in the test group. In some embodiments, the predicted post-campaign spending for the test group does not account for campaign exposure. In some embodiments, post-campaign spending for households in the test group, or a subgroup thereof, can be estimated using the model defined in Eq. 1 above, using the estimated values for α, β₁, β₂, . . . βₖ, and the f₁, f₂, . . . fₖ calculated from the control group. When a subgroup of households in the control group is employed to estimate the aggregate first per-consumer-purchase amount, in some embodiments, a corresponding subgroup of households in the test group can be employed for determining the aggregate second per-consumer-purchase amount. In this manner, when the control group and the test group are constructed so as to have matching households/subgroups of households, it can be assumed that the one would exhibit similar purchasing behavior to the other, and the estimated values/functions (β, β₁, β₂, . . . βₖ, and the f₁, f₂, . . . fₖ) from the control group can be employed to estimate post-campaign spending for the test group as if they had not been exposed to the campaign.

In this manner, the measurement module 232 is configurable to both receive observed consumer spending information (i.e., receive Y for the test group) as well as estimate consumer spending information (i.e., estimate Ŷ) for the test group. In some embodiments, the second per-consumer-purchase amount is calculated based on the difference between the observed post-campaign spending for the test group, or a subset thereof, and the estimated post-campaign spending for the test group, or the subset thereof, such as based on Eq. 3 below.

eₜ=Yₜ−Ŷₜ (3)

where the subscript t denotes that the calculation is performed on a household from the test group.

In some embodiments, the aggregate second per-consumer-purchase amount for the test group is the average, sum, median, and/or any other suitable mathematical operation(s), linear or non-linear, on the difference between the known post-campaign spending and the estimated post-campaign spending.

The measurement module 232 is further configurable to send a signal indicative of a net purchase value for the promoted entity due to the campaign. In some embodiments, the net purchase value is calculated as the difference between the aggregate first-per-consumer purchase amount and the aggregate second-per-consumer-purchase amount. The term “difference” as used herein is intended to include any mathematical operation operable to discriminate between two or more values in a linear or non-linear manner, and can encompass linear subtraction.

As an example, if the aggregate first -per-consumer purchase amount for the control group is the average of the household value e_{c} (from Eq. 2, denoted ē_{c}) and the aggregate second -per-consumer-purchase amount for the test group is the average of the household value eₜ (from Eq. 3, denoted ēₜ), then in some embodiments, the net change in purchase activity attributed to the promoted entity is calculated by Eq. 4:

Δ=ēₜ−ē_{c} (4)

In some embodiments, the value ē_{c} is calculated with the weights that were used to align the test and control groups.

As an example, assume that the aggregate (observed) first -per-consumer purchase amount ē_{c} for the control group is zero, but for a subgroup of the control group is −$0.02. This indicates that on average, the subgroup of the control group spent about 2 cents less on the promoted entity after the campaign than the overall control group, and can account for differences in spending for reasons other than the campaign itself (e.g., some peculiar factors that may affect the subgroup alone), since the control group as a whole is not exposed to the campaign. Further, assume that the aggregate second -per-consumer purchase amount (ēₜ) for a corresponding subgroup of the test group is $0.03. This indicates that on average, the subgroup of the test group spent about 3 cents more on the promoted entity post-campaign than the overall control group, after being exposed to the campaign. However, since the subgroup of the test group is substantially similar to the subgroup of the control group, it is reasonably exposed to the same factors that led to the subgroup of the control group spending $0.02 less on average. This effect can be accounted for, and the effect of the campaign on the purchasing habits of the subgroup of the test group effectively isolated, by calculating a net purchase value of Δ=ēₜ−ē_{c}=0.03−(−0.02)=$0.05. Said another way, the campaign increased spending on the promoted entity by the subgroup of the test group by $0.05 on average, which is more significant and accurate than the observed $0.03 increase in spending. Benefits of the approach(es) disclosed herein hence include the ability to isolate campaign effects by taking into account other effects. For example, accounting for similarities in spending behavior, demographics and digital activity. Further, the net purchase value can be calculated across all (as exemplified above) or any subgroup of households in the test/control groups, and provides a quantitative measure of the extent to which the campaign affected purchasing behavior for that particular subgroup of households.

In some embodiments, the measurement module 232 is further configurable to determine effectiveness of the one or more communications based on, but not limited to, one or more of the following:

a. a number of communications—e.g. the number of times the test group household was targeted/exposed;

b. one or more types of communications—e.g., an online/offline advertisement;

c. one or more sources associated with the communications—e.g., on a social media website, on a smartphone application, one or more retailers, etc.;

d. a per-communication cost associated with the communications—e.g., a cost calculated based on the size/location of the communication, the location it is rendered, a contractual price, etc.; and

e. communication velocity—e.g. timing information associated with the communications, magnitude information associated with the communications, persistence information associated with the communications.

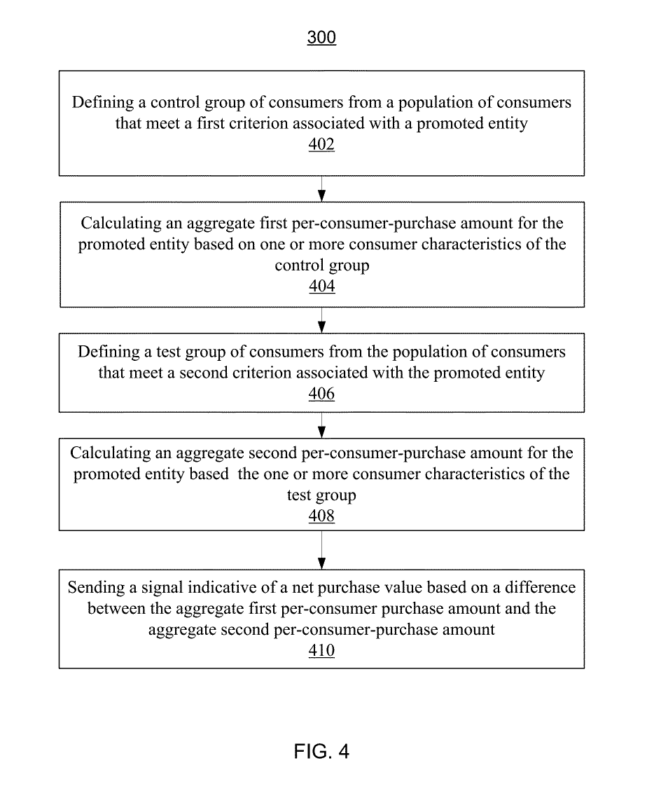

FIG. 4 is a flow chart illustrating a method 400 according to an embodiment. In some embodiments, the method 400 is for measurement of campaign effectiveness by calculating the net purchase value for a promoted entity associated with the advertising campaign. The method 400 can be performed by the apparatus 200, or any apparatus structurally/functionally similar to the apparatus 200. Particularly, instructions associated with performing the method 400 can be stored in a memory of the apparatus (e.g., the memory 224 of the apparatus 200 in FIG. 1) and executed in a processor of the apparatus (e.g., the processor 222 of the apparatus 100 in FIG. 2).

At 402, the processor 222 can be configured to define a control group of consumers from a population of consumers that meet a first criterion associated with a promoted entity. In some embodiments, the promoted entity is one or more of the following: a product, a class of products, a brand of a product, a retailer, a manufacturer, a group, an organization, and a professional service. In some embodiments, the first criterion includes that the control group has not been exposed to one or more communications about the promoted entity. In some embodiments, the communication associated with the promoted entity is an online advertisement for the promoted entity.

At 404, the processor 222 can be configured to calculate an aggregate first per-consumer-purchase amount for the promoted entity based on one or more consumer characteristics of the control group. In some embodiments, the one or more consumer characteristics are selected from pre-communication transaction information for the promoted entity, demographic information, and digital activity information. In some embodiments, calculating the aggregate first-per-consumer-purchase amount includes adjusting for one or more factors not associated with the one or more communications.

At 406, the processor 222 can be configured to define a test group of consumers from the population of consumers that meet a second criterion associated with the promoted entity. In some embodiments, the second criterion includes that the test group has been exposed to one or more communications about the promoted entity.

At 408, the processor 222 can be configured to calculate an aggregate second per-consumer-purchase amount for the promoted entity based on the one or more consumer characteristics of the test group.

At 410, the processor 222 can be configured to send a signal indicative of a net purchase value. The net purchase value is based on a difference between the aggregate first per-consumer purchase amount and the aggregate second per-consumer-purchase amount.

In some embodiments, the method 400 can further include (not shown), and the processor 122 can be further configured to, define the population of consumers from a matched consumer record set that includes each record from a first consumer record set that has hashed a attribute string equal to a hashed attribute string of a record from a second consumer record set.

In some embodiments, the method 400 can further include (not shown), and the processor 222 can be further configured to, determine effectiveness of the one or more communications based on one or more of the following:

a. a number of the one or more communications;

b. one or more types of the one or more communications;

c. one or more sources associated with the one or more communications;

d. a per-communication cost associated with the one or more communications; and

e. communication velocity.

In some embodiments, a non-transitory processor-readable medium (e.g. the memory 224 of the apparatus 200 of FIG. 2) stores code representing instructions to cause a processor (e.g. the processor 222 of the apparatus 200 of FIG. 2) to perform a process, such as a process encompassing the method 400 of FIG. 4. In some embodiments, the process can perform measurement of campaign effectiveness by calculating the net purchase value for a promoted entity associated with the advertising campaign.

In some embodiments, the code includes code to define a control group of consumers from a population of consumers that meet a first criterion associated with a promoted entity. In some embodiments, the first criterion includes that the control group has not been exposed to one or more communications about the promoted entity. In some embodiments, the code further includes code to define the population of consumers from a matched consumer record set that includes each record from a first consumer record set that has hashed an attribute string equal to a hashed attribute string of a record from a second consumer record set. In some embodiments, the communication associated with the promoted entity is an online advertisement for the promoted entity. In some embodiments, the promoted entity is one or more of the following: a product, a class of products, a brand of a product, a retailer, a manufacturer, a group, an organization, and a professional service.

In some embodiments, the code further includes code to calculate an aggregate first-per-consumer-purchase amount for the promoted entity based on one or more consumer characteristics of the control group. In some embodiments, the one or more consumer characteristics is selected from pre-communication transaction information for the promoted entity, demographic information, and digital activity information. In some embodiments, the code further includes code to calculate the aggregate first-per-consumer-purchase amount by adjusting for one or more factors not associated with the one or more communications.

In some embodiments, the code further includes code to define a test group of consumers from the population of consumers that meet a second criterion associated with a promoted entity. In some embodiments, the second criterion includes that the test group has been exposed to one or more communications about the promoted entity.

In some embodiments, the code further includes code to calculate an aggregate second-per-consumer purchase amount for the promoted entity based on the one or more consumer characteristics of the test group.

In some embodiments, the code further includes code to send a signal indicative of a net purchase value. The net purchase value is based on a difference between the aggregate first-per-consumer purchase amount and the aggregate second-per-consumer-purchase amount.

In some embodiments, the code can further include code to determine effectiveness of the one or more communications based on one or more of the following:

a. a number of the one or more communications;

b. one or more types of the one or more communications;

c. one or more sources associated with the one or more communications;

d. a per-communication cost associated with the one or more communications; and

e. communication velocity.

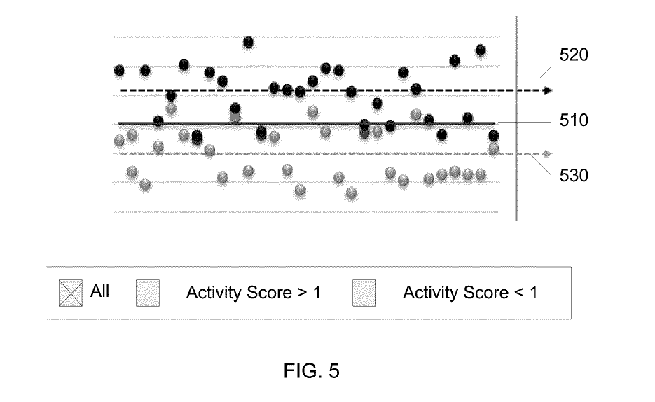

Referring again to FIG. 1, it is understood that in some embodiments, the measurement module 232 can estimate the per-consumer purchase amount for each consumer per eq. 2 above without any knowledge of test and control groups. Said another way, since the per-consumer purchase amount determination is independent of whether the consumer was exposed to the communication or not, this determination can be performed prior to selecting the test and control groups. The determination of the aggregate first per-consumer-purchase amount, the aggregate second per-consumer-purchase amount, and the net purchase value can be made after the control and test groups are determined. At the very least, the control and test groups are based on the unexposed/exposed criterion. As discussed earlier, additional filters can be employed. FIG. 5 illustrates an exemplary approach and interface for such filters, and illustrates all consumers being currently displayed and accounted for in the determination of the aggregate first per-consumer-purchase amount (line 530), the aggregate second per-consumer-purchase amount (line 520), and the net purchase value. FIG. 5 also illustrates that a user can filter the consumers based on digital activity score, which can result in a recalculation of the aggregate first per-consumer-purchase amount, the aggregate second per-consumer-purchase amount, and the net purchase value for the filtered consumer set (i.e., with narrowed test and control groups), and which can update the view illustrated in FIG. 5.

The processor 222 can be any suitable processor configured to run and/or execute the module(s) included in the processor 222. Each module in the processor 222 can be any combination of hardware-based module (e.g., a field-programmable gate array (FPGA), an application specific integrated circuit (ASIC), a digital signal processor (DSP)) and/or software-based module (e.g., a module of computer code stored in memory and/or executed at the processor 222) capable of performing one or more specific functions associated with that module. In some embodiments, the processor 222 can include other module(s) (not shown in FIG. 3) configured to perform other function(s) for the apparatus 220. For example, the processor 222 can include a visualization module configured to generate different views of the household data in the database 240, of the total revenue lift for subpopulations of interest, and/or the like.

In some embodiments, the memory 224 can be, for example, a random-access memory (RAM) (e.g., a dynamic RAM, a static RAM), a flash memory, a removable memory, and/or so forth. Information associated with performing the collection, matching, and/or measurement processes can be stored, maintained and updated in the memory 224. In some embodiments, the memory 224 encompasses the database 240. Additionally, although not shown in FIG. 4, other data or information can be stored in other portions of the memory 124.

The methods described herein are examples of how to implement-measurement of campaign effectiveness, and further, how to implement net purchase value determination. It is intended that the systems and methods described herein can be performed by software (stored in memory and/or executed on hardware), hardware, or a combination thereof Hardware modules may include, for example, a general-purpose processor, a field programmable gate array (FPGA), and/or an application specific integrated circuit (ASIC). Software modules (executed on hardware) can be expressed in a variety of software languages (e.g., computer code), including Unix utilities, C, C++, Java™, Ruby, SQL, SAS®, the R programming language/software environment, Visual Basic™, and other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. Additional examples of computer code include, but are not limited to, control signals, encrypted code, and compressed code.

Some embodiments described herein relate to devices with a non-transitory computer-readable medium (also can be referred to as a non-transitory processor-readable medium or memory) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

While various embodiments have been described above, it should be understood that they have been presented by way of example only, and not limitation. Where methods and steps described above indicate certain events occurring in certain order, the ordering of certain steps may be modified. Additionally, certain of the steps may be performed concurrently in a parallel process when possible, as well as performed sequentially as described above. Although various embodiments have been described as having particular features and/or combinations of components, other embodiments are possible having any combination or sub-combination of any features and/or components from any of the embodiments described herein.

What is claimed is:

1. A method, comprising:
defining a control group of consumers from a population of consumers that meet a first criterion associated with a promoted entity;
calculating an aggregate first per-consumer-purchase amount for the promoted entity based on one or more consumer characteristics of the control group;
defining a test group of consumers from the population of consumers that meet a second criterion associated with the promoted entity;
calculating an aggregate second per-consumer-purchase amount for the promoted entity based the one or more consumer characteristics of the test group;
sending a signal indicative of a net purchase value based on a difference between the aggregate first per-consumer purchase amount and the aggregate second per-consumer-purchase amount.

2. The method of claim 1, wherein the one or more consumer characteristics are selected from pre-communication transaction information for the promoted entity, demographic information, and digital activity information.

3. The method of claim 1, wherein the promoted entity is one or more of the following: a product, a class of products, a brand of a product, a retailer, a manufacturer, a group, an organization, and a professional service.

4. The method of claim 1, wherein the first criterion includes that the control group has not been exposed to one or more communications about the promoted entity, and
wherein the communication associated with the promoted entity is an online advertisement for the promoted entity.

5. The method of claim 1, further comprising defining the population of consumers from a matched consumer record set that includes each record from a first consumer record set that has hashed a attribute string equal to a hashed attribute string of a record from a second consumer record set.

6. The method of claim 1, wherein the second criterion includes that the test group has been exposed to one or more communications about the promoted entity, the method further comprising determining effectiveness of the one or more communications based on one or more of the following:
a number of the one or more communications;
one or more types of the one or more communications;
one or more sources associated with the one or more communications;
a per-communication cost associated with the one or more communications; and
communication velocity.

7. The method of claim 1, wherein the first criterion includes that the control group has not been exposed to one or more communications about the promoted entity, calculating the aggregate first-per-consumer-purchase amount including adjusting for one or more factors not associated with the one or more communications.

8. An apparatus, comprising:
a consumer module configured to:
define a control group of consumers from a population of consumers that meet a first criterion associated with a promoted entity; and
define a test group of consumers from the population of consumers that meet a second criterion associated with the promoted entity; and
a measurement module configured to:
calculate an aggregate first-per-consumer-purchase amount for the promoted entity based on one or more consumer characteristics of the control group;
calculate an aggregate second-per-consumer purchase amount for the promoted entity based the one or more consumer characteristics of the test group; and
send a signal indicative of a net purchase value based on a difference between the aggregate first -per-consumer purchase amount and the aggregate second -per-consumer-purchase amount.

9. The apparatus of claim 8, wherein the promoted entity is one or more of the following: a product, a class of products, a brand of a product, a retailer, a manufacturer, a group, an organization, and a professional service.

10. The apparatus of claim 8, wherein the communication for the promoted entity is an offline advertisement for the promoted entity.

11. The apparatus of claim 8, wherein the one or more consumer characteristics selected from pre-communication transaction information for the promoted entity, demographic information, and digital activity information.

12. The apparatus of claim 8, wherein the one or more consumer characteristics does not include a consumer purchase amount.

13. The apparatus of claim 8, wherein the second criterion includes that the test group has been exposed to one or more communications about the promoted entity, the measurement module further configured to determine effectiveness of the one or more communications based on one or more of the following:
a number of the one or more communications;
one or more types of the one or more communications;
one or more sources associated with the one or more communications;
a per-communication cost associated with the one or more communications; and
communication velocity.

14. The apparatus of claim 8, wherein the first criterion includes that the control group has not been exposed to one or more communications about the promoted entity,
the measurement module further configured to calculate the aggregate first-per-consumer-purchase amount by adjusting for one or more factors not associated with the one or more communications.

15. A non-transitory processor-readable medium storing code representing instructions to cause a processor to perform a process, the code comprising code to:
define a control group of consumers from a population of consumers that meet a first criterion associated with a promoted entity;
calculate an aggregate first-per-consumer-purchase amount for the promoted entity based on one or more consumer characteristics of the control group;
define a test group of consumers from the population of consumers that meet a second criterion associated with a promoted entity;
calculate an aggregate second-per-consumer purchase amount for the promoted entity based the one or more consumer characteristics of the test group;
send a signal indicative of a net purchase value based on a difference between the aggregate first-per-consumer purchase amount and the aggregate second-per-consumer-purchase amount.

16. The non-transitory processor-readable medium storing code representing instructions to cause a processor to perform the process of claim 15, wherein the one or more consumer characteristics is selected from pre-communication transaction information for the promoted entity, demographic information, and digital activity information.

17. The non-transitory processor-readable medium storing code representing instructions to cause a processor to perform the process of claim 15, wherein the promoted entity is one or more of the following: a product, a class of products, a brand of a product, a retailer, a manufacturer, a group, an organization, and a professional service.

18. The non-transitory processor-readable medium storing code representing instructions to cause a processor to perform the process of claim 15, wherein the communication associated with the promoted entity is an online advertisement for the promoted entity.

19. The non-transitory processor-readable medium storing code representing instructions to cause a processor to perform the process of claim 15, the code further comprising code to define the population of consumers from a matched consumer record set that includes each record from a first consumer record set that has hashed a attribute string equal to a hashed attribute string of a record from a second consumer record set.

20. The non-transitory processor-readable medium storing code representing instructions to cause a processor to perform the process of claim 15, wherein the second criterion includes that the test group has been exposed to one or more communications about the promoted entity, the code further comprising code to determine effectiveness of the one or more communications based on one or more of the following:
a number of the one or more communications;
one or more types of the one or more communications;
one or more sources associated with the one or more communications;
a per-communication cost associated with the one or more communications; and
communication velocity.

21. The non-transitory processor-readable medium storing code representing instructions to cause a processor to perform the process of 15, wherein the first criterion includes that the control group has not been exposed to one or more communications about the promoted entity,
the code further comprising code to calculate the aggregate first-per-consumer-purchase amount by adjusting for one or more factors not associated with the one or more communications.
